(19) United States
(12) Patent Application Publication
(10) Pub. No.: US 2023/0211399 A1
(43) Pub. Date: Jul. 6, 2023

(54) COMPOSITE ROD AND ITS PROCESSING METHOD

(71) Applicant: AUTUMN INC., Houston, TX (US)

(72) Inventor: Qiucheng TIAN, Houston, TX (US)

(21) Appl. No.: 17/568,976

(22) Filed: Jan. 5, 2022

(51) Int. Cl. B21C 37/04; C25D 3/04; C25D 3/56

(52) U.S. Cl. CPC B21C 37/042; B21C 37/045; C25D 3/04; C25D 3/562

(57) ABSTRACT

This invention relates to a composite mandrel and its processing technology, including: processing, connection, welding, alloy overlaying, tempering after overlaying, polishing, chrome plating etc., on the whole and auxiliary body of mandrel. The composite mandrel includes a plurality of main and auxiliary bodies, the surface is overlaid with high temperature resistant, wear resistant, thermal fatigue resistant alloy, polished, and chrome plated, obtaining the characteristics of wear resistance, thermal fatigue resistance and high temperature resistance. The whole process not only increase the strength, toughness and hardness of the mandrel, improves its service quality, but also prolong the service life. With simple structure and reliable quality, composite mandrel can meet the requirements of different running condition. Whether for new-made mandrels, or for equal diameter renewal of failed mandrels, composite mandrel process can show its advantages of suitable material quantity, energy saving, consumption reduction, and production cost reduction.

### TECHNICAL FIELD

The invention claims a low-carbon and environmentally friendly composite rod which can be repeatedly repaired and used, as well as its processing method, which belongs to the field of steel pipe manufacturing.

### BACKGROUND TECHNOLOGY

Rods are important processes parts for seamless steel pipe manufacturing, and their qualities determine processing qualities of seamless steel pipes. Therefore, precision requirements on rods are high; however, since rods can be longer than 10 m, they are difficult to be processed, and rods with partial damages can be used for manufacturing, and this makes manufacturing cost of rods high. How to repair and reuse rods with partial damages had always been one of unsolved issues in rod processing and manufacturing industry. Both precision and strength requirements on rods are high, in addition, rods are damageable during seamless steel pipe processing. While conducting extending transformation and repairing modification over rods, not only structural strength, but also surface hardness and smoothness of rods shall be guaranteed. Generally, in ordinary extending transformation and structure connection, connecting mandrels are installed in the center of ends of to-be-connected rods, but it is found in applications that anti-flex strengths at connected positions of such rods are weak and can easily break again; in general repair, carbonized layers and damages are usually removed from surfaces of used rods to process smaller-diameter rods, so rods get slimmer upon each repair and must be scrapped after 1-2 repairs. Even if rod materials are still useful, they can't be used as rods due to small diameters; utilization rates of rod materials are low, service lives of rods are short, consumption of rod materials and manufacturing cost of rods are high. How to improve the surface hardness and smoothness of rods? How to extend service lives of rods? How to reduce processing cost of rods? How to connect short rods into needed long ones in accordance with requirements? How to repair rods with surface damages into conforming ones under the same diameters? The invention claims a composite rod and its processing method.

### SUMMARY

In order to overcome above defects in rod structures and processing technologies, the invention provides a composite rod and its processing method on basis of rod using technology. With the invention, not only service lives of rods can be extended and processing cost can be reduced, but also the mechanical strength, surface hardness and smoothness of rods can be assured, in addition, short rods can be connected into needed long ones in accordance with requirements, and rods with surface damages can be repaired into conforming ones under the same diameters.

The technical scheme disclosed and protected by the invention: A composite rod and its processing method; the composite rod comprises: (1) the main body of the rod, (2) the auxiliary body of the rod, (3) the inner thread at end of the main body of the rod, (4) the outer thread at end of the auxiliary body of the rod, (5) the annular shaft slots, (6) the alloy resurfacing welding layer, (7) the electroplating layer, (8) the cone-frustum end of the main body of the rod, (9) the connector at tail of the auxiliary body of the rod; processing method of the composite rod: (10) processing of the outer circle and the annular shaft slot of the main body of the rod, (11) processing of the outer circle and the annular shaft slot of the auxiliary body of the rod, (12) processing of the inner thread at end of the main body of the rod and the cone-frustum end of the main body of rod, (13) processing of the outer thread at end of the auxiliary body of the rod and the connector at tail of the auxiliary body of the rod, (14) connection and welding of the threads of the main body and the auxiliary body of the rod, (15) welding the two end surfaces of the thread connection, (16) resurfacing welding of high-temperature and wear-resistant alloy for the entire rod, (17) high-temperature annealing after resurfacing welding, (18) grinding and polishing of the alloy resurfacing welding layer, (19) electroplating chromium for the entire rod, (20) inspection over the composite rod; characteristics: the main body of the rod (1) and the auxiliary body of the rod (2) are connected and welded through the inner thread at end of the main body of the rod (3) and the outer thread at end of the auxiliary body of the rod (4); the alloy resurfacing welding layer (6) is evenly resurfacing welded on cylinder surfaces of the main body of the rod (1) and the auxiliary body of the rod (2) and in the annular shaft slots (5), upon high-temperature annealing after resurfacing welding (17) and grinding and polishing of the alloy resurfacing welding layer (18), electroplating chromium for the entire rod (19) is carried out, the electroplating layer (7) is formed, finally, inspection over the composite rod (20) is conducted, if such inspection is passed, processing and manufacturing of the composite rod is finished, otherwise, processing shall be repeated with the composite rod processing technology.

As a further improvement of above technical scheme, the alloy resurfacing welding layer (6) can be different alloy resurfacing welding layers, such as high-temperature and wear-resistant hard layer.

As a further improvement of above technical scheme, depth, width and distribution of the annular shaft slots (5) on cylinder surfaces of the main body of the rod (1) and the auxiliary body of the rod (2) can be designed according to damages on rod surface.

As a further improvement of above technical scheme, both type and thickness of the alloy resurfacing welding layer (6) on cylinder surface of the composite rod can be determined on basis of processing and manufacturing cost and specification requirements of rod.

As a further improvement of above technical scheme, both temperature and approach of annealing after resurfacing welding can be determined according to base material of rod and type of the alloy resurfacing welding layer (6).

As a further improvement of above technical scheme, the electroplating layer (7) can be electroplated with chromium or other alloys, such as nickel tungsten alloy.

Preferred, in order to meet rod using technology requirements and assure processing quality of rods, the composite rod must have high proper alignment and cylindricity.

Preferred, in order to meet rod using technology requirements and extend service lives of rods, the composite rod must be grinded primarily, secondarily and finally to achieve excellent surface smoothness.

Preferred, in order to reduce processing cost of rods and improve utilization ratios of base materials of rods, the composite rod can comprise of several main bodies and auxiliary bodies meeting rod using technology requirements.

Compared to existing rods and their processing technologies, the invention has following advantages:

1. Reasonable design. Rod is a workpiece with long shaft, not only requirements on steel rolling technology are high under overall design, but also processing and manufacturing of rods are difficult, it is obvious that design of the composite rod is more reasonable.

2. Simple structure and easy manufacturing. The composite rod is suitable for extending and diameter-maintaining transformations, not only broken rods can be repaired and extended, but also diameter-shortened rods can be repaired and restored.

3. Reliable repair quality. High-strength alloy layer is resurfacing welded on cylinder surface of rod, not only the hardness and strength of base material of rod can be supplemented, but also the structural strength and toughness of the composite rod can be enhanced.

4. Low processing and manufacturing cost. For both manufacturing new rods and repairing rods, the invention can be applied to different materials and manufacturing can be carried out according to specific dimensions, not only materials, but also energies and consumptions can be saved.

5. Long service life of rod. The entire composite rod is resurfacing welded with an alloy layer, grinded, polished and electroplated with chromium, not only overall wear resistance, drag resistance and high-temperature resistance of rods can be improved, but also the surface hardness of rods can be enhanced and service lives of rods can be extended.

### BENEFICIAL EFFECTS OF THE INVENTION

All using data of the composite rods, which adopt the invention, reach design indexes, manufacturing technology requirements are met in steeling rolling and pipe manufacturing.

About the composite rods that adopt the invention, energy consumption and cost are reduced, and production efficiency is improved.

### DESCRIPTION OF ATTACHED FIGURES

FIG. 1 depicts structure of the invention;

FIG. 2 depicts A-A direction enlarged cross-sectional view of the invention;

FIG. 3 depicts flow chart of the invention.

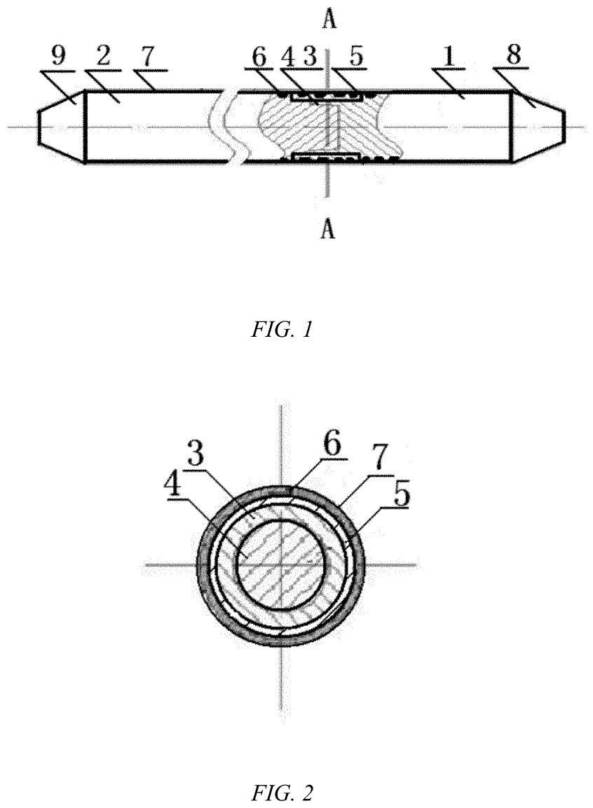

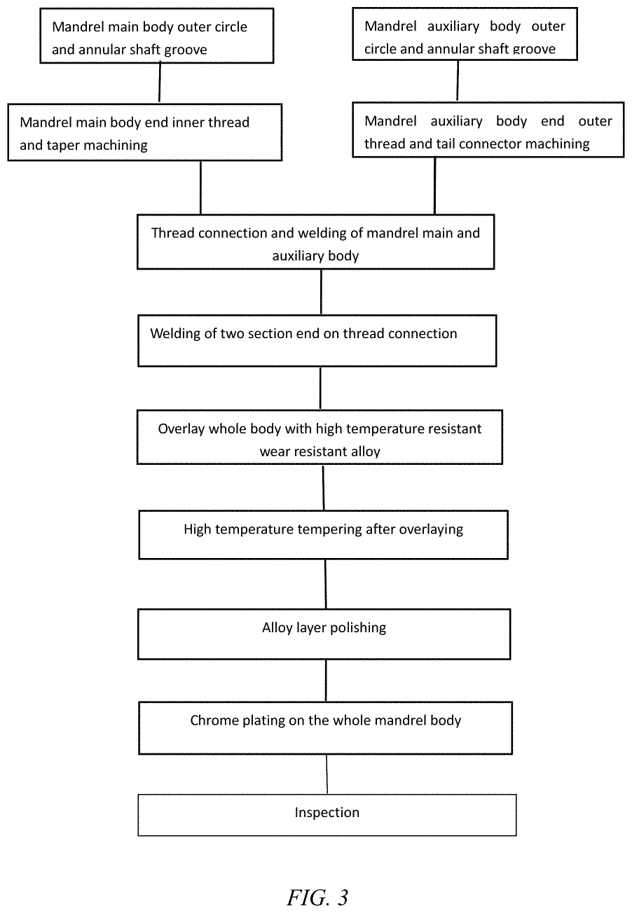

### SPECIFIC EMBODIMENTS

### Embodiments

The invention is further detailed below by combining attached figures and specific embodiments; following embodiments are descriptive rather than restrictive, and shall not restrict protection scope of the invention.

A composite rod and its processing method; the composite rod comprises: (1) the main body of the rod, (2) the auxiliary body of the rod, (3) the inner thread at end of the main body of the rod, (4) the outer thread at end of the auxiliary body of the rod, (5) the annular shaft slots, (6) the alloy resurfacing welding layer, (7) the electroplating layer, (8) the cone-frustum end of the main body of the rod, (9) the connector at tail of the auxiliary body of the rod; processing method of the composite rod: (10) processing of the outer circle and the annular shaft slot of the main body of the rod, (11) processing of the outer circle and the annular shaft slot of the auxiliary body of the rod, (12) processing of the inner thread at end of the main body of the rod and the cone-frustum end of the main body of rod, (13) processing of the outer thread at end of the auxiliary body of the rod and the connector at tail of the auxiliary body of the rod, (14) connection and welding of the threads of the main body and the auxiliary body of the rod, (15) welding of the thread connection, (16) resurfacing welding of high-temperature and wear-resistant alloy for the entire rod, (17) high-temperature annealing after resurfacing welding, (18) grinding and polishing of the alloy resurfacing welding layer, (19) electroplating chromium for the entire rod, (20) inspection over the composite rod; characteristics: the main body of the rod (1) and the auxiliary body of the rod (2) are connected and welded through the inner thread at end of the main body of the rod (3) and the outer thread at end of the auxiliary body of the rod (4); the alloy resurfacing welding layer (6) is evenly resurfacing welded on cylinder surfaces of the main body of the rod (1) and the auxiliary body of the rod (2) and in the annular shaft slots (5), upon high-temperature annealing after resurfacing welding (17) and grinding and polishing of the alloy resurfacing welding layer (18), electroplating chromium for the entire rod (19) is carried out, the electroplating layer (7) is formed, finally, inspection over the composite rod (20) is conducted, if such inspection is passed, processing and manufacturing of the composite rod is finished, otherwise, processing shall be repeated with the composite rod processing technology.

Practice has proved that, the composite rods manufactured in accordance with above scheme can satisfy manufacturing technology needs of seamless steel pipes under different diameters, manufacturing costs of rods are reduced, qualities of rods are improved and service lives of rods are extended. The invention is of simple structure and easy operation, it is safe and reliable, it has a wide application range and can be easily promoted and used.

Finally, it shall be clarified that, above embodiments are only for describing rather than restricting technical scheme of the invention; although the invention is described in detail by referring preferred embodiments, common technicians of the field shall understand that: within spirits and scopes of the invention and attached claims, modifying or replacing technical scheme of the invention is possible, therefore, scope of the invention is not limited to the contents disclosed in above embodiments and attached figures, and all contents within spirits and scopes of the invention and attached claims shall be covered by protection scope of the invention.

1. A composite core rod, comprising:
a composite core rod comprising: a core rod main body, a core rod auxiliary body, an internal thread located at the end of the core rod main body, an external thread located at the end of the core rod auxiliary body, an annular shaft groove, an alloy surfacing layer, a electroplated layer, a cone end of the core rod main body, and a tail end connector of the core rod auxiliary body.

2. The composite core rod according to claim 1, wherein: the depth and width, as well as shaft groove distribution of the annular shaft groove on the cylindrical surface of the core rod main body and auxiliary body are designed according to the damage condition of the core rod surface and thickness of the surfacing layer.

3. The composite core rod according to claim 1, wherein the alloy surfacing layer is a high temperature and abrasion-resistant hard alloy layer.

4. The composite core rod according to claim 1, wherein the composite core rod consists of 1-2 core rod main bodies and 0-2 core rod auxiliary bodies.

5. The composite core rod according to claim 1, wherein the type and thickness of the alloy surfacing layer can be selected according to the manufacturing cost of the core rod and specifications of the core rod.

6. The composite core rod according to claim 1, wherein the annealing temperature and method after the surfacing can be selected according to the base material of the core rod and type of the alloy surfacing layer.

7. The composite core rod according to claim 1, wherein the electroplated layer is a metal chromium electroplated layer or a nickel-tungsten alloy electroplated layer.

8. A method of processing the composite core rod of claim 1, comprising:
processing the outer circle of the core rod main body and the annular shaft groove processing; processing of outer circle of the core rod auxiliary body and the annular shaft groove processing; processing the internal thread at the end of the core rod main body and the cone end processing; processing external thread at the end of the core rod auxiliary body and the tail end connector processing, the threaded connection and welding of the main and auxiliary bodies of the core rod, welding of the threaded connection; surfacing high-temperature and abrasion-resistant alloy on the cylindrical surface of the core rod, high temperature annealing after surfacing, grinding and polishing alloy surfacing layer, electroplating metal chromium on the whole core rod, and composite core rod inspection;
wherein the core rod main body and auxiliary body are connected and welded with the external thread at the end of the core rod auxiliary body through the internal thread at the end of the core rod main body; the alloy surfacing layer is uniformly surfacing welded on the core rod main body, cylindrical surface of the core rod auxiliary body and its annular shaft groove, high temperature annealing after surfacing, after grinding and polishing the alloy surfacing layer, electroplating metal chromium on the cylindrical surface of the core rod to form a layer of electroplated metal chromium, and finally the composite core rod is inspected; after inspection, the processing and manufacturing of the composite core rod is completed. Otherwise, the composite core rod is reprocessed and manufactured according to the composite core rod processing technology.
